(19) United States
(12) Patent Application Publication
(10) Pub. No.: US 2005/0205131 A1
(43) Pub. Date: Sep. 22, 2005

(54) Solution tank and method of storing solution

(75) Inventor: Yukihiro Katai, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/074,783

(22) Filed: Mar. 9, 2005

(30) Foreign Application Priority Data
Mar. 19, 2004 (JP) 2004-081282

(51) Int. Cl. B67D 5/54

(52) U.S. Cl. 137/209

(57) ABSTRACT

A solution tank stores dope containing solute and solvent. There is a flow path for flow of saturated gas generated by a saturated gas generator into a tank body. The saturated gas contains a main component of the solvent, for example, methyl acetate. The saturated gas maintains gas-liquid equilibrium. A condition of
Tg≦Ti≦TL is satisfied, where TL (° C.) is temperature of a liquid phase region inside the tank body, Ti (° C.) is temperature of a gas/liquid interface inside the tank body, and Tg (° C.) is temperature of a gas phase region inside the tank body. Furthermore, a liquid reservoir chamber is disposed in the tank body, generates the saturated gas containing the main component of the solvent, and causes contact of the saturated gas with the dope.

### BACKGROUND OF THE INVENTION

1. Field of the Invention

The present invention relates to a solution tank and method of storing solution. More particularly, the present invention relates to a solution tank and method of storing solution, in which unwanted precipitation of solute of polymer can be effectively prevented.

2. Description Related to the Prior Art

A solution casting is a method of producing polymer film from cellulose acylate, in particular cellulose triacetate (TAC). The polymer film of cellulose triacetate (TAC) is well-known in wide uses as a base film of photosensitive material or transparent sheet on a liquid crystal display panel. A process of producing polymer film of cellulose triacetate (TAC) is typically disclosed in JIII Journal of Technical Disclosure Monthly (Japan Hatsumei Kyokai, Kokai Giho), No. 2001-1745, pages 2-6. At first cellulose triacetate (TAC) is dissolved in a mixed solvent of which a main component is dichloro methane, to prepare dope or polymer solution. After this, the dope is cast on a support, for example a support belt or rotatable supporting drum, to form cast film. When the cast film dries to have a self-supporting property, the cast film is stripped by a stripping roller. The cast film is sufficiently dried and cooled, and wound as a roll of the polymer film.

There is a recently known technique for the purpose of raising productivity of dope. At first dope with low density of cellulose triacetate (TAC) is prepared. Then the dope is condensed by a condenser, so dope with high density is obtained and used for casting. Also, there is public requirement of high performance of optical elements for which polymer film of cellulose triacetate (TAC) is used. In film forming or thread spinning by use of dope, the dope with high density is stored in a storing solution tank associated with a condenser by way of a dope reservoir. The dope is delivered from the storing solution tank and suitably used for the purpose of film forming and thread spinning. However, it is usual that solvent gasifies to precipitate the solute on the gas/liquid interface of the dope while the storing solution tank stores the dope. There occurs unwanted precipitated polymer from the solute, which may mix with the dope and will become an obstacle to acceptably normal operation of the film forming and thread forming. Particularly if dope with the high density is stored, unwanted precipitated polymer is very likely to occur upon any reduction in the solvent because the solute stands dissolved nearly in a saturated state. Also, if a filtration device is used for removing unwanted precipitated polymer by filtration, considerably great load is likely to applied to the filtration device to shorten its useful life.

### SUMMARY OF THE INVENTION

In view of the foregoing problems, an object of the present invention is to provide a solution tank and method of storing solution, in which unwanted precipitation of solute of polymer can be effectively prevented.

In order to achieve the above and other objects and advantages of this invention, a solution tank for storing solution containing solute and solvent, is provided, and includes a tank body. There is a flow path for flow of saturated gas generated by a saturated gas generator into the tank body, wherein the saturated gas contains a main component of the solvent.

The saturated gas maintains gas-liquid equilibrium.

Furthermore, at least one warming device adjusts temperature of the tank body.

The at least one warming device comprises plural warming devices arranged in a direction of a depth of the tank body.

Furthermore, a temperature controller discretely controls temperature of the plural warming devices.

A condition of
Tg≦Ti≦TL
is satisfied, where TL (° C.) is temperature of a liquid phase region inside the tank body;
Ti (° C.) is temperature of a gas/liquid interface inside the tank body; and
Tg (° C.) is temperature of a gas phase region inside the tank body.

Furthermore, an auxiliary saturated gas generator is disposed in the tank body, for generating the saturated gas that contains the main component of the solvent, and for causing contact of the saturated gas with the solution.

The auxiliary saturated gas generator includes a liquid reservoir chamber, disposed in one portion of the tank body, for storing the main component of the solvent in the liquid phase.

A condition of
Ti−10≦Ts(° C.)≦Ti+10
is satisfied, where Ti (° C.) is temperature of a gas/liquid interface inside the tank body; and
Ts (° C.) is temperature of the liquid reservoir chamber.

The solute includes at least one polymer.

The polymer comprises cellulose acylate.

The main component of the solvent is chlorine-free solvent.

The chlorine-free solvent comprises acylic acid ester.

The solution tank is positioned downstream from a dissolving tank, and supplied with the solution thereby, and the dissolving tank produces the solution by dissolving the solute in the solvent.

The solution tank is positioned upstream from a solution casting apparatus, and supplies the solution thereto, and the solution casting apparatus produces polymer film from the solute by casting the solution.

According to one aspect of the invention, a solution tank for storing solution containing solute and solvent is provided, and includes a tank body. An auxiliary saturated gas generator is disposed in the tank body, for generating saturated gas that contains a main component of the solvent, and for causing contact of the saturated gas with the solution, to maintain gas-liquid equilibrium.

According to another aspect of the invention, a solution storing method of storing solution containing solute and solvent in a solution tank is provided. Saturated gas containing a main component of the solvent is supplied into the solution tank in supplying the solution, for maintaining gas-liquid equilibrium.

According to still another aspect of the invention, a solution storing method of storing solution containing solute and solvent in a solution tank is provided. An auxiliary saturated gas generator in the solution tank is used, for generating saturated gas that contains a main component of the solvent, and for maintaining gas-liquid equilibrium so as to prevent reduction of the solvent in a liquid phase.

According to the invention, it is possible effectively to prevent unwanted precipitation of solute of polymer, because the saturated gas of the main component of the solvent is filled with the gas phase region inside the tank body to keep the gas-liquid equilibrium.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating a system for producing dope;

FIG. 2 is a cross section, partially broken, illustrating one storing solution tank;

FIG. 3 is a cross section, partially broken, illustrating another preferred storing solution tank;

FIG. 4 is an explanatory view illustrating a solution casting apparatus for use with the dope;

FIG. 5 is an explanatory view in cross section, illustrating a solution casting apparatus with a multi-manifold structure;

FIG. 6 is an explanatory view in elevation, illustrating a solution casting apparatus including a feed block for plural dopes; and

FIG. 7 is an explanatory view in cross section, illustrating a solution casting apparatus with plural dies.

### DETAILED DESCRIPTION OF THE PREFERRED EMBODIMENT(S)OF THE PRESENT INVENTION

Solution to be stored in the solution tank and according to the storing method is not limited to particular substance. It is possible in the invention to store solution of triphenyl phosphate (TPP) which is widely used as a plasticizer. An example used in preferred embodiments of the invention is herein dope or solution of cellulose triacetate (TAC). However, any polymer other than cellulose triacetate or cellulose acylate may be used as solute in the solution.

[Solute]

Polymer is used as solute in the invention. The polymer may be any compound without being limited, but should be high-molecular compounds of cellulose. Examples among those can be cellulose esters, preferably cellulose acylates, and desirably cellulose acetates. In particular among the cellulose acetates, cellulose triacetate (TAC) having an average acetyl value of 57.5-62.5% is the most preferable. Note that the acetyl value or degree of acetylation means an amount of acetic acid per unit weight of cellulose. The acetyl value or degree of acetylation used herein is measured and calculated according to the ASTM: D-817-91 for a measuring method of cellulose acetate and the like. According to the invention, particles of cellulose acylate or triacetate are used. 90 wt. % or more of the used particles has a particle diameter of 0.1-4 mm, preferably 1-4 mm. In particular, a ratio of the particles with a particle diameter of 1-4 mm should be 95 wt. % or more, rather preferably 97 wt. % or more, preferably 98 wt. % or more, and the most preferably 99 wt. % or more. Furthermore, 50 wt. % or more of the used particles should have a particle diameter of 2-3 mm. In particular, a ratio of the particles with a particle diameter of 2-3 mm should be 70 wt. % or more, preferably 80 wt. % or more, and the most preferably 90 wt. % or more. The particles of cellulose acylate can have a shape that is as near to a sphere as possible.

The solute to be dissolved according to the invention may be additive agents of various substances. Examples of additive agents are plasticizers, ultraviolet absorbers, releasers, stripping promoters, and fluorine containing surface active agents. Note that additives may be added in the course of dissolving polymer in solvent, but also may be added during the solution casting and between a dope containing vessel and a casting die.

Examples of the plasticizers include phosphoric acid esters, such as triphenyl phosphate (TPP), tricresyl phosphate, cresyl diphenyl phosphate, octyl diphenyl phosphate, biphenyl diphenyl phosphate, trioctyl phosphate, and tributyl phosphate; phthalic acid esters, such as diethyl phthalate, dimethoxy ethyl phthalate, dimethyl phthalate, and dioctyl phthalate; glycolic acid esters, such as triacetin, tributylin, butyl phthalyl butyl glycolate, ethyl phthalyl ethyl glycolate (referred to also as ethyl phthalyl glycol ethyl ester), methyl phthalyl ethyl glycolate, and butyl phthalyl butyl glycolate; and acetates, such as dipenta erythritol hexaacetate, and ditrimethylol propane tetraacetate. Two or more plasticizers among those may be used in combination.

Examples of the ultraviolet absorbers (UV agents) include oxy benzophenone compounds, benzo triazol compounds, compounds of salicylic acid esters, benzophenone compounds, cyano acrylate compounds, and compounds of nickel complex salts. Also, a combination of two or more of those can be used.

[Solvent]

Solvent may be any compound without being limited, but should a compound with a low boiling point so as to obtain effects to suppress precipitation of solute even upon volatilization of the solvent. Examples of solvents can be aliphatic hydrocarbons, such as hexane, and n-heptane; halogenated hydrocarbons, such as dichloro methane, and chloroform; aromatic hydrocarbons, such as benzene; esters, such as methyl acetate, methyl formate, ethyl acetate, amyl acetate, and butyl acetate; ketones, such as acetone, methyl ethyl ketone, and cyclohexanone; ethers, such as dioxane, dioxolane, tetrahydro furane, diethyl ether, and methyl-tert-butyl ether; and alcohols, such as methanol, ethanol, and n-butanol. Also, a combination of two or more of those can be used. Note that the term of solvent hereinafter used will be also related to mixed solvent.

[Production of Solution]

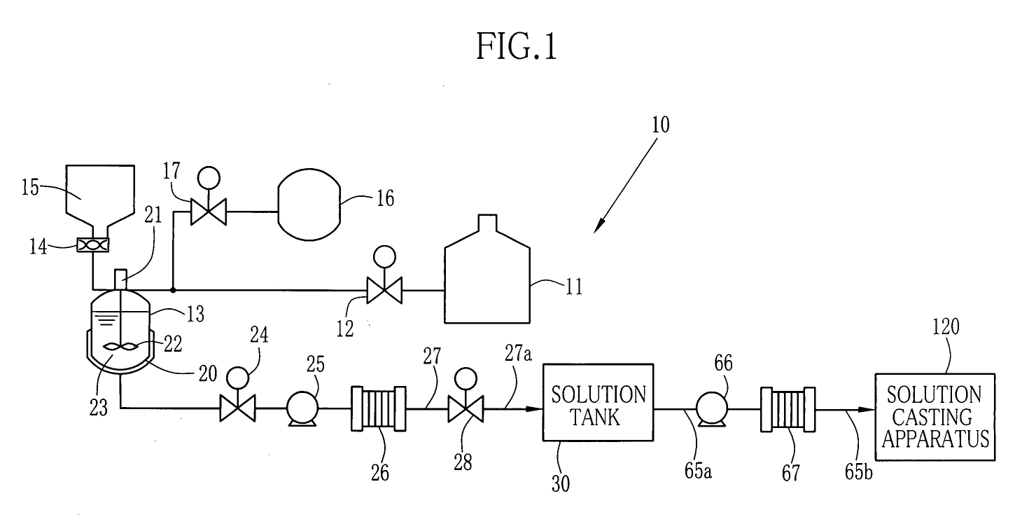

Dope of cellulose triacetate (TAC) is described as solution. In FIG. 1, a dope producing apparatus 10 is illustrated, and includes a solvent delivery tank 11, a dissolving tank 13, a polymer hopper 15 and an additive agent tank 16. At the solvent delivery tank 11, a valve 12 is opened at first. Solvent is supplied to the dissolving tank 13 from the solvent delivery tank 11. A measuring device 14 is operated at the polymer hopper 15 to measure polymer, which is sent from the polymer hopper 15 to the dissolving tank 13. Note that a valve 17 is actuated for opening and closing the additive agent tank 16 if required, to send solution of additive to the dissolving tank 13. Furthermore, if the additive is liquid and flowable at a room temperature, it is also possible to send an additive in a liquid phase to the dissolving tank 13. If an additive is solid at a room temperature, it is possible to supply the additive by a hopper to the dissolving tank 13. Note that two or more additives can be used in combination according to the invention. Various methods may be used for supply of plural additives. For example, the additive agent tank 16 can contain two or more additives previously. Also, two or more additive agent tanks can be used, so plural separate conduits can be used for supplying the dissolving tank 13 with the additives.

An order of sending the solvent, cellulose triacetate (TAC) and the additives to the dissolving tank 13 for the dope may be modified. For example, cellulose triacetate (TAC) can be supplied to the dissolving tank 13 before the solvent. Also, no previous supply of the additives into the dissolving tank 13 is required. Additives can be added to the mixture of cellulose triacetate (TAC) and the solvent in a subsequent step in the producing process.

A warming jacket 20 is attached to the dissolving tank 13, and controls temperature of the inside of the dissolving tank 13 by flowing of heat exchange medium of fluid. There are stirring blades 22 which a motor 21 causes to rotate. The stirring blades 22 stir the solvent for the dissolving tank 13, so dope 23 as solution is obtained by dissolving solute or polymer in the solvent. In producing the dope 23, various steps of heating and cooling can be combined suitably so that dope can be prepared with still higher density.

There is a pump 25, with which a valve 24 is connected in an upstream position. A filtration device 26 is connected downstream from the pump 25. The dope 23 is supplied by the pump 25 to the filtration device 26, which eliminates impurity from the dope 23. A storing solution tank 30 is supplied with the dope 23, and stores the same. It is possible in the storing solution tank 30 to condense the dope 23. There is a solution casting apparatus 120, with which conduits 65a and 65b are connected with outlets of the storing solution tank 30. A pump 66 is connected between the conduits 65a and 65b, and supplies the solution casting apparatus 120 with the dope 23. It is preferable to use a filtration device 67 between the pump 66 and the solution casting apparatus 120 in order to filtrate the dope 23 after being stored. The solution casting for producing polymer film will be described later in detail.

[Solution Storing Method]

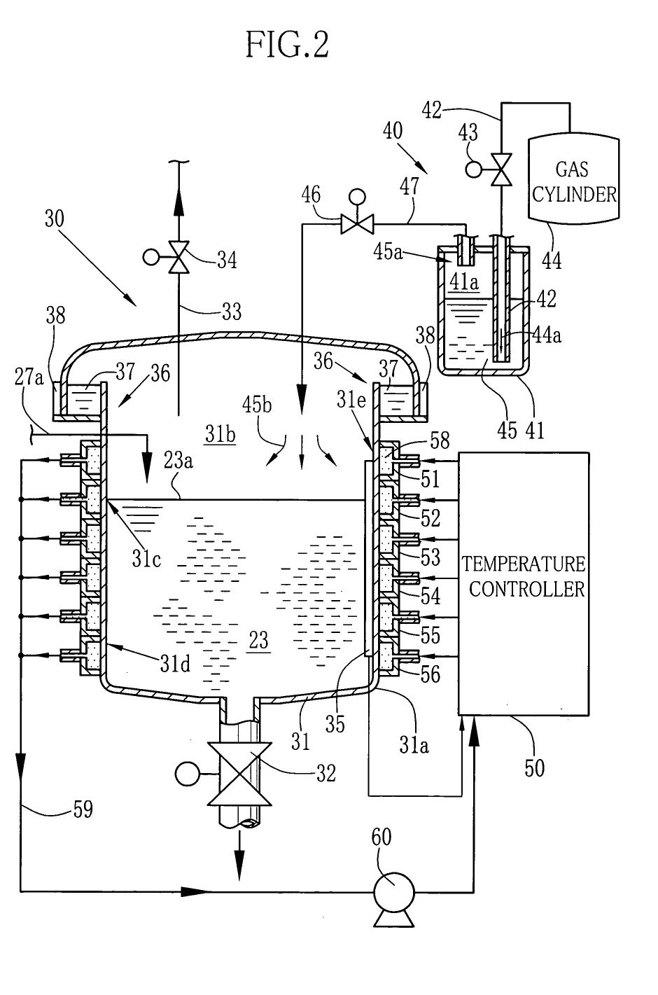

In FIG. 2, the storing solution tank 30 for storing according to the invention is illustrated. A tank body 31 of the storing solution tank 30 is connected with a saturated gas generator 40. An outer surface 31a of the tank body 31 is provided with warming jackets 51, 52, 53, 54, 55 and 56 as warming devices, which are connected with a temperature controller 50. It is preferable to control the temperature of the tank body 31 by use of the warming jackets 51-56. A conduit 27a, a valve 32, and a degassing vent 33 are connected with the storing solution tank 30. The conduit 27a of FIG. 1 supplies the dope 23 into the tank body 31. The valve 32 is associated with an outlet for the dope. While the dope 23 is poured into the tank body 31, a valve 34 is actuated to open and close the degassing vent 33, to remove gas from the tank body 31. There is a surface level sensor 35 for detecting a liquid surface 23a of the dope 23. Information of a stored amount is generated by the surface level sensor 35, and monitored in comparison with a predetermined amount. Then pouring of the dope 23 is interrupted to keep the dope 23 contained as poured. There occurs an upper space 31b defined higher than the liquid surface 23a and inside the tank body 31. The dope 23 does not exist in the upper space 31b, namely a gas phase region.

The saturated gas generator 40 is constituted by a vessel 41, a conduit 42 and a valve 43. A gas cylinder 44 is connected with the conduit 42 where the valve 43 opens and closes the flow path. Solvent 45 mainly with a chlorine-free compound is contained in the vessel 41, and has a composition ratio equal to that of the solvent included in the dope 23. One end of the conduit 42 is positioned within the solvent 45. Gas 44a, for example nitrogen, is caused to flow from the gas cylinder 44 by opening and closing the valve 43, and bubbled in the solvent 45 upon the flow in the conduit 42. Part of by the solvent 45 is volatilized by the bubbling to become gas 45a. The gas 45a is substituted for part of air or gas in an upper space 41a of the vessel 41. Continuing the bubbling substitutes the gas 45a for most of the gas in the upper space 41a. The ratio of this substitution should be most preferably 100%, but may be a volume ratio in a range of 50-100% in consideration of substitution time, manufacturing cost and the like. A term of saturated gas 45b of solvent is used to refer to this gas. It is noted that any gaseous substance may be used for the gas 44a in the gas cylinder 44. Examples of the gas 44a can be nitrogen and helium, and preferably nitrogen in view of a low cost. Commercially available gas may be used for the gas 44a, which however should have water content of preferably 100 p.p.m. or less. Furthermore, it is desirable on the conduit 42 to use a moisture absorbing conduit (not shown) with desiccant filled therein, in order to eliminate water content from the gas 44a.

Another preferred embodiment is described by referring to the storing solution tank 30 depicted in FIG. 2. Elements similar to those in the above embodiment are designated with identical reference numerals. The saturated gas 45b is blown by the saturated gas generator 40 continuously while the dope 23 is stored. It is possible to keep open the valve 34 at the degassing vent 33 while the dope 23 is stored. Even when the inside of the tank body 31 of the storing solution tank 30 becomes warmer by heat to raise the pressure in the upper space 31b by volatilizing the solvent in the dope 23, gas is removed through the degassing vent 33 to prevent breakage of the storing solution tank 30. If gas in the upper space 31b is removed through the degassing vent 33 by degassing, the saturated gas generator 40 generates the saturated gas 45b which blows to the inside of the tank body 31 without interruption. Thus, the gas-liquid equilibrium between the saturated gas 45b and solvent in the dope 23 can be maintained. A level of the liquid surface 23a can be unchanged, to prevent occurrence of unwanted precipitated solute.

In FIG. 2, a valve 46 is connected with the tank body 31 at a conduit 47 as a flow path. The saturated gas 45b is sent into the tank body 31 in adjustment of a gas amount set by opening and closing the valve 46. The saturated gas 45b is substituted for the gas in the upper space 31b, to keep a gas-liquid equilibrium of the solvent in the dope 23. It is possible to use any one of known gas composition analyzing methods, to check whether the substitution for the upper space 31b with the saturated gas 45b is completed. For example, part of the gas contained in the upper space 31b is sampled, and subjected to gas chromatography mass spectrometry as an example of gas composition analyzing method. The dope 23 is stored by stopping a flow path to the tank body 31 to keep the tank body 31 hermetically closed. Even though the solvent in the dope 23 gasifies, part of the saturated gas 45b in the upper space 31b liquefies to maintain the gas-liquid equilibrium. A level of the liquid surface 23a of the dope 23 in the tank body 31 is kept unchanged. A gas/liquid interface 31c is prevented from having an unwanted precipitated solute of polymer from the dope 23.

The warming jackets 51-56 are disposed on the outside of the outer surface 31a. Heat exchange medium 58 of a fluid substance is caused to flow through the warming jackets 51-56, so that occurrence of unwanted precipitated polymer is suppressed by the temperature control. The heat exchange medium 58 may be any one of liquid or gas. The term of the heat exchange medium 58 is used herein to refer to any selected one of those two. An example of the heat exchange medium 58 can be any one of water, oil, ethylene glycol and the like, and most desirably is water. A circulating system used preferably includes a conduit 59 and a pump 60. The heat exchange medium 58 is caused by the pump 60 to flow through the conduit 59 and back to the temperature controller 50. This circulating system is advantageous in view of low cost. Note that the temperature control of the heat exchange medium 58 in the temperature controller 50 is according to known techniques including a heat exchanger. However, any one of devices for temperature control may be used. In spite of the combination of the warming jackets 51-56 according to FIG. 2, it is possible in the invention to control the temperature in a manner different from the six split sections of the warming jackets 51-56.

The feature of the invention is to control the temperature of the tank body 31 to maintain the gas-liquid equilibrium so as to prevent unwanted precipitated polymer to occur. Let TL (° C.) be temperature of a liquid phase region 31d. Let Ti (° C.) be temperature of the gas/liquid interface 31c. Let Tg (° C.) be temperature of a gas phase region 31e. Each of the liquid phase region 31d, the gas/liquid interface 31c and the gas phase region 31e is one portion of the inner surface of the tank body 31. Three values of the temperatures are controlled to satisfy the condition of:
Tg≦Ti≦TL Condition 1

First, the temperature Ti of the gas/liquid interface 31c is set equal to or less than the temperature TL of the liquid phase region 31d, to prevent occurrence of unwanted precipitated polymer by suppressing volatilization of the solvent in the dope 23 from the gas/liquid interface 31c. Also, the temperature Tg of the gas phase region 31e is set equal to or less than the temperature Ti of the gas/liquid interface 31c and the temperature TL of the liquid phase region 31d, so as to eliminate an unwanted precipitated polymer even if the unwanted precipitated polymer with a small thickness has occurred on the gas/liquid interface 31c. This is because the polymer can be dissolved again into the dope 23 by the liquefaction of the saturated gas 45b on the inner surface about the gas phase region 31e. Note that the temperature TL of the liquid phase region 31d, temperature Ti of the gas/liquid interface 31c and the temperature Tg of the gas phase region 31e are controlled by means of the warming jackets 53-56, 52 and 51.

The temperature control for Condition 1 may be automated. The surface level sensor 35 detects a position of the liquid surface 23a to generate a position signal. Plural thermometers (not shown) are attached to the tank body 31, and detect plural values of the temperature to generate temperature signals. Those signals are input to the temperature controller 50. A controller (not shown) in the temperature controller 50 is responsive to the signals, changes the temperature of the heat exchange medium 58 for flow toward the warming jackets 51-56. This is effective in automatically controlling the temperature of the liquid phase region 31d, the gas/liquid interface 31c and the gas phase region 31e of the tank body 31. A main component of the dope 23 is, for example, 60 wt. % of methyl acetate. It is preferable that the temperature Tg of the gas phase region 31e, the temperature Ti of the gas/liquid interface 31c, and the temperature TL of the liquid phase region 31d satisfy the conditions of:
10° C.≦Tg≦55° C.,
15° C.≦Ti≦55° C.,
20° C.≦TL≦60° C.

In FIG. 2, the temperature controller 50 is single for the control of the warming jackets 51-56. However, a plurality of the temperature controller 50 can be arranged, each one of which may be associated with one of the warming jackets 51-56.

In the present embodiment, it is preferable that a source for generating the solvent gas is added in the tank body 31. In FIG. 2, a liquid reservoir chamber 36 as an auxiliary saturated gas generator is disposed in the tank body 31. Replenishing solvent 37 mainly with a chlorine-free compound is contained in the liquid reservoir chamber 36, and is a composition the same as a main component of the solvent in the dope 23. Temperature Ts of the liquid reservoir chamber 36 is controlled substantially equal to the temperature Ti of the gas/liquid interface 31c, to maintain the gas-liquid equilibrium in the upper space 31b. Unwanted precipitated polymer is prevented from occurrence in the gas/liquid interface 31c. Specifically, the temperature Ts of the liquid reservoir chamber 36 desirably satisfies the condition of
Ti−10≦Ts(° C.)≦Ti+10
for the purpose of well keeping the gas-liquid equilibrium of the upper space 31b and preventing the unwanted precipitation in the gas/liquid interface 31c. Note that the level of the temperature Ts may a value not limited in this condition.

The temperature control of the temperature Ts can be according to known techniques. For example, a temperature controller 38 depicted in the drawing may be used. Also, a jacket may be associated with the liquid reservoir chamber 36. Also, the use of the liquid reservoir chamber 36 in the tank body 31 makes it possible to omit the use of the saturated gas generator 40. Yet it is the most preferable to use the saturated gas generator 40 in combination with the liquid reservoir chamber 36 to supply the upper space 31b with saturated solvent gas. The gas-liquid equilibrium is well maintained to prevent occurrence of unwanted precipitated polymer. Various shapes and volumes of the liquid reservoir chamber 36 may be determined differently from that depicted. If the interfacial area S1 of the dope 23 is in a range of 0.03-20 m², it is preferable that the interfacial area S2 in the liquid reservoir chamber 36 for the solvent is in a range of 0.01-5 m². Also, the ratio S1/S2 of those can preferably satisfy the condition of 1≦S1/S2≦10. As is described heretofore, the dope 23 is kept stored either by hermetically closing the tank body 31 or by blowing the saturated gas 45b toward the dope 23. For solution casting by use of the dope 23, the valve 32 is opened to send the dope 23 toward the solution casting apparatus 120. See FIG. 1. The solution casting for polymer film will be described later in detail.

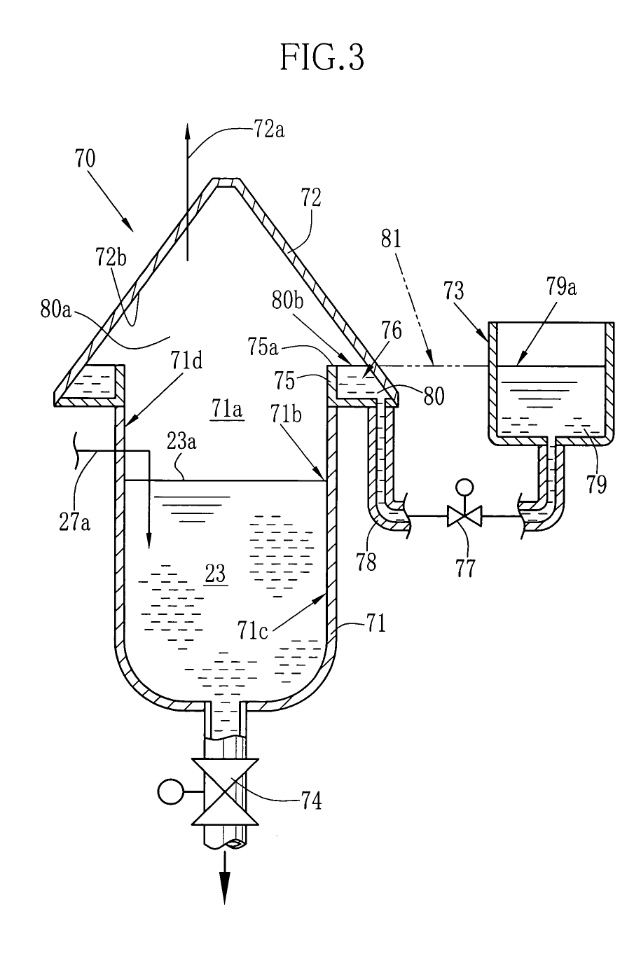

In FIG. 3, a storing solution tank 70 is illustrated. The storing solution tank 70 also operates for condensing the dope 23. The storing solution tank 70 includes a tank body 71, a lid panel 72 and a valve 74, the valve 74 being used for flowing out of the dope 23. A solvent delivery device 73 is connected with the storing solution tank 70. A barrage 75 is formed to project from the inside of the tank body 71. A liquid reservoir chamber 76 as an auxiliary saturated gas generator is defined by one side of the barrage 75 and a portion of the lid panel 72. A conduit 78 as a flow path extends from the solvent delivery device 73 to the storing solution tank 70. A valve 77 is associated with the conduit 78. Mixed solvent 79 mainly with a chlorine-free compound is contained in the solvent delivery device 73, and is a composition substantially the same as composition of the solvent in the dope 23. A degassing vent 72a is formed through the lid panel 72 for passage of gas.

The solvent delivery device 73 sends the solvent 79 through the valve 77 and the conduit 78 to the liquid reservoir chamber 76. Solvent stored in the liquid reservoir chamber 76 is referred to as replenishing solvent 80. Part of the replenishing solvent 80 is volatilized and becomes gaseous solvent. An upper space 71a is filled with saturated gas 80a of solvent from the replenishing solvent 80. The replenishing solvent 80 decreases because of volatilization. However, the solvent delivery device 73 remains connected with the liquid reservoir chamber 76. The solvent delivery device 73 sends the solvent 79 to the liquid reservoir chamber 76 in order to keep a liquid surface 79a and a reservoir liquid surface 80b at a constant level of a reference surface 81.

The dope 23 is poured into the tank body 71 through the conduit 27a. For the dope 23, see FIG. 1. In the course of the pouring, the degassing vent 72a is kept open. As the upper space 71a has the state of gas-liquid equilibrium, part of the saturated gas 80a liquefies even upon volatilization of part of the solvent in the dope 23. A level of the liquid surface 23a is maintained constantly. A gas/liquid interface 71b of the tank body 71 can be free from occurrence of unwanted precipitated polymer. Note that the lid panel 72 has a triangular shape as viewed in section. An inner surface 72b is so large that a ratio in the area between the inner surface 72b and the liquid surface 23a is greater than that of the storing solution tank 30 according to the first embodiment of FIG. 2. It is easy to maintain the equilibrium between the saturated gas 80a and the solvent in the dope 23. After this, the degassing vent 72a is closed, so the dope 23 is stored. At the time of using the dope 23, the valve 74 is opened to send the dope 23 to the solution casting apparatus 120 of FIG. 1. The production of the polymer film by solution casting will be described later.

An amount of the solvent in the liquid reservoir chamber 76 is such that its liquid surface is flush with a front end 75a of the barrage 75. When solvent volatilizes from the dope 23, and becomes condensed by the lid panel 72 and withdrawn in the liquid reservoir chamber 76, solvent at an equal amount is overflown and returns to the dope 23. Consequently, it is possible to keep unchanged an amount of the solvent contained in the dope 23.

In the tank body 71, a liquid phase region 71c and a gas phase region 71d are defined by the presence of the dope 23. In storing the dope 23 in the storing solution tank 70, the temperature control device (not shown) with a jacket or the like can be associated with the storing solution tank 70 in the same manner as the storing solution tank 30 of FIG. 2. The temperature Ti of the gas/liquid interface 71b, the temperature TL of the liquid phase region 71c, and the temperature Tg of the gas phase region 71d are controlled according to the condition
Tg≦Ti≦TL
so that occurrence of unwanted precipitated polymer can be prevented with reliable effects.

[Solution Casting]

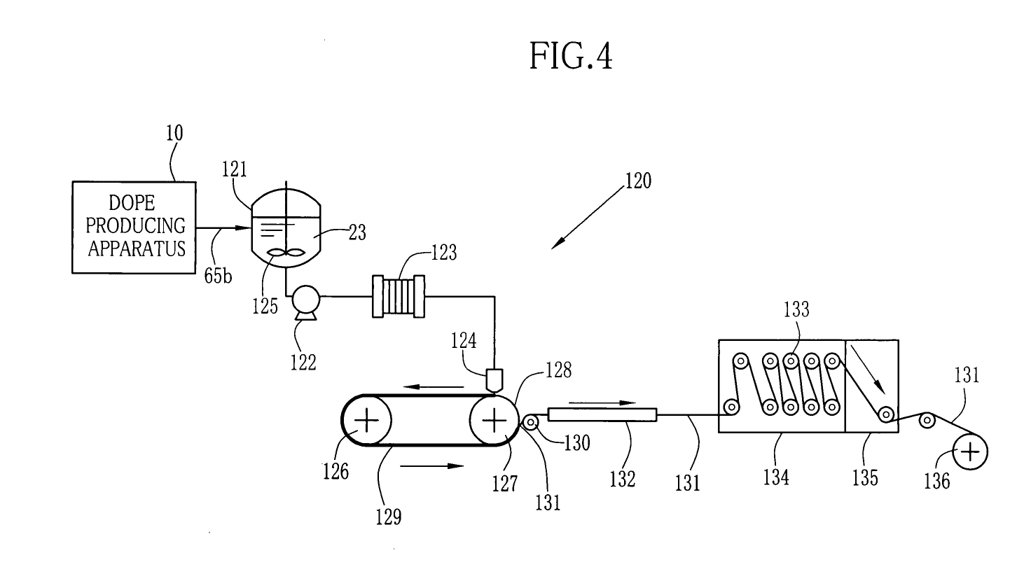

In FIG. 4, the solution casting apparatus 120 used in the solution casting of the present invention is illustrated. The dope 23 is prepared and stored in one of the storing solution tanks 30 and 70 in the dope producing apparatus 10 described above. A mixing tank 121 is provided with the dope 23 by a flow through the conduits 65a and 65b. A die 124 is connected with the mixing tank 121 via a pump 122 and a filtration device 123. Stirring blades 125 are incorporated in the mixing tank 121, and rotated by a motor (not shown). The stirring blades 125 keep the dope 23 in a uniformly dispersed form by stirring. Also, additive agents can be mixed with the dope 23 in the mixing tank 121, including plasticizers, ultraviolet absorbers and the like. The phase or form of the additive agents to be used may be solid or liquid or a solution obtained by dissolving the same. It is preferable to use the additive agent solution by storing according to the solution tank and storing method of the present invention. Unwanted precipitated part of the additive agents can be very little. Existence of foreign material in the dope 23 can be suppressed and prevented. As a result, defects in the polymer film after the casting will be reduced. It is possible in the solution casting apparatus 120 to reduce load to the filtration device 123. A filtration material in the filtration device 123 can have a long life in repeated use. Maintenance and management of the solution casting apparatus 120 can be easy.

A support belt 128 is disposed under the die 124. There are rollers 126 and 127 having the periphery on which the support belt 128 is supported to extend. A drive mechanism (not shown) rotates the rollers 126 and 127 so as to turn the support belt 128 in an endless manner. The dope 23 is sent by the pump 122 from the mixing tank 121, filtrated in the filtration device 123 for removal of impurity, and is then sent to the die 124. The dope 23 is cast by the die 124 on to the support belt 128, to form cast film 129. Note that the cast film 129 is also called gel film. The cast film 129 becomes dried gradually to have self-supporting properties while transported on the support belt 128. A stripping roller 130 supports and also strips the cast film 129 from the support belt 128, to obtain polymer film 131 of cellulose acylate.

A tenter type of drier 132 with a tentering mechanism transports, stretches and dries the polymer film 131. Stretching on at least one axis for a predetermined web edge is preferable for the purpose of raising product quality in view of polymer film surfaces which will be obtained subsequently. There is a drying chamber 134 where plural rollers 133 are incorporated. When the polymer film 131 is transported from the drier 132 into the drying chamber 134, the polymer film 131 is dried while transported by rotation of the rollers 133. A cooling chamber 135 cools the polymer film 131, which a winder 136 winds in a roll form. It is possible to subject the polymer film 131 moving out of the cooling chamber 135 to slitting of a web edge, or to knurling before the winding operation. Note that it is possible to use a rotatable drum or casting drum in the present invention in contrast with the support belt in FIG. 6.

[Solution Casting for Multi-Layer Forming]

In the above embodiment, the die 124 operates for a single-layer forming of polymer film. However, solution casting used in the present invention may be multi-layer forming distinct from the single-layer forming. Various preferred embodiments will be hereinafter described with reference to the drawings. Elements similar to those of the solution casting apparatus 120 in FIG. 4 are designated with identical reference numerals.

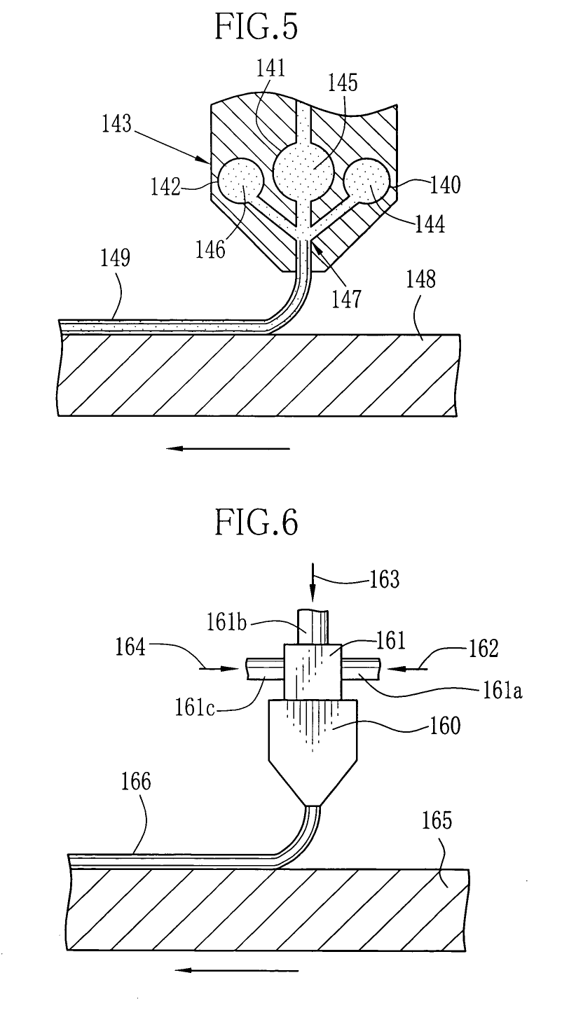

FIG. 5 is referred to for describing the multi-manifold casting. A multi-manifold type of die 143 includes plural manifolds 140, 141 and 142. Dopes 144, 145 and 146 as solution are supplied to the manifolds 140-142. There are conduits (not shown) for the supply of the dopes. A convergence portion 147 causes convergence of the dopes 144-146. A support belt 148 extends under the multi-manifold die 143. The dopes 144-146 are cast on the support belt 148 to form cast film 149. The cast film 149 is dried to obtain polymer film.

In FIG. 6, another preferred embodiment is illustrated. A casting device includes a die 160, a feed block 161, and a support belt 165. Three conduits 161a, 161b and 161c communicate with the feed block 161 as entrances connected with a dope delivery device. Dopes 162, 163 and 164 flow through the conduits 161a-161c, and converge together in the die 160. Cast film 166 is formed from the dopes 162-164 on the support belt 165, and dried to obtain polymer film. Note that the support used in FIGS. 5 and 6 may be a rotatable support drum or casting drum instead of the support belt 165.

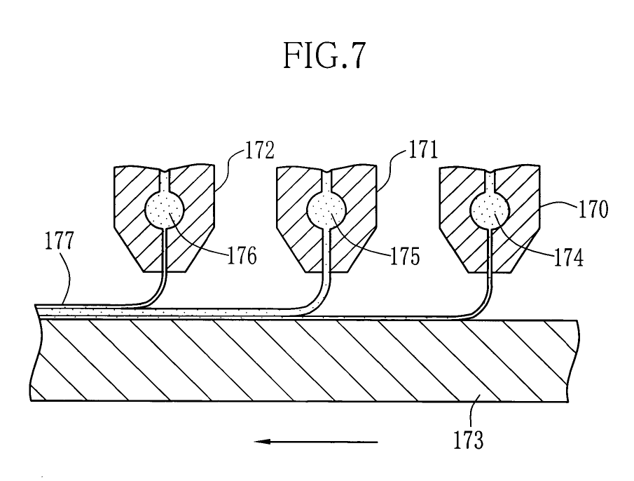

In FIG. 7, a consecutive type of solution casting is illustrated. Three dies 170, 171 and 172 are arranged over a support belt 173. Dopes 174, 175 and 176 are supplied to the dies 170-172 by a supply device (not shown). The dopes 174-176 are cast on to the support belt 173 in a consecutive manner, so cast film 177 is formed. The cast film 177 is dried to obtain polymer film of a multi-layer structure. Note that it is also possible to combine the consecutive solution casting of FIG. 7 with the multi-film solution casting of FIG. 5 or 6.

Plural dopes being cast in the process of multi-layer forming, it is preferable among the plural dopes that at least one dope is stored according to the storing of the present invention. It is the most desirable that all of the dopes being used are stored according to the storing of the present invention. Furthermore, it is preferable to store additive in the liquid phase according to the storing of the present invention before mixing the additive to the dope in the solution casting apparatus 120. This is favorable in obtaining the polymer film of which surface quality is high owing to being free from mixture of unwanted precipitation of the solute.

[Polymer Film and Product]

The polymer film obtained by the solution casting of any one of the above embodiments is cut into samples in a size of 5 cm². Five samples of each one of the same polymer films are produced. Those are observed in a manner of the crossed Nicol. The size of bright point defects and the average values of the number of such defects are checked, so that it is possible to observe a successful suppression of occurrence of unwanted precipitated polymer in the dope.

It is possible for the use of photosensitive material that the polymer film has the bright point defect number of 0 per area of at most 5 cm² when the bright point defect size is 20 microns or more, and the defect number of 10 per area of at most 5 cm² when the defect size is equal to or more than 10 microns and less than 20 microns, and the defect number of 10 per area of 5 cm² when the defect size is equal to or more than 5 microns and less than 10 microns. The polymer film obtained by the embodiments of the invention can satisfy those conditions, and thus can be used as a base film of photosensitive materials, protective film for a polarizer plate, and various optical elements.

The polymer film obtained by the solution casting of the invention is favorable because of a small number of bright point defects and high quality of a surface, and thus can be used as a polarizer protection film. Two polarizer protection films are attached to a polarizing film formed from polyvinyl alcohol or the like, so that a polarizer plate can be formed. Also, optical compensatory film may be obtained by attaching the polymer film on an optical compensatory sheet. An anti-reflection layer may be obtained by coating the polymer film with an antiglare layer. At least one portion of such elements may be used for constituting device.

### EXAMPLES

Examples of the invention are described hereinafter in detail. Of course, the features of the invention are not limited to the examples. Experiment No. 1 will be described in detail. For Experiments Nos. 2-4, their portion where Experiment No. 1 is repeated will not be mentioned further.

[Production of Dopes]

In Experiment No. 1, the dope producing line of FIG. 1 was used to produce the dopes. The dissolving tank 13 of stainless steel had an inner volume of 2 m³, and supplied from the solvent delivery tank 11 with mixed solvent in the mixture ratio described below. After this, flake or powder of cellulose triacetate (TAC) was well stirred and dispersed, and poured into the same gradually by use of the measuring device 14. Then plasticizers as additives were suitably poured to prepare the composition with a total weight of 2,000 kg. The stirring blades 22 were rotated for sixty minutes, to agitate materials to prepare the dope 23. The filtration device 67 had a hole diameter of 10 microns. Any one of the dichloro methane, methanol, ethanol and 1-butanol in the solvent in use had a water content of 0.1 wt. % or less.

[Material for Dopes]

17 Parts by weight of particles of cellulose triacetate (substitution degree: 2.83, viscosity average degree of polymerization (DP): 320, water content: 0.4 wt. %, viscosity of 6 wt. % dichloro methane solution: 305 mPa.s, average particle diameter and standard deviation of the particle diameter: 1.5 mm and 0.5 mm);
63 parts by weight of dichloro methane (as chlorine containing compound);
5 parts by weight of methanol;
5 parts by weight of ethanol;
5 parts by weight of 1-butanol;
1.2 parts by weight of dipenta erythritol hexaacetate as plasticizer;
1.2 parts by weight of triphenylphosphate or TPP as plasticizer;
0.2 part by weight of UV absorber a, i.e. 2,4-bis-(n-octylthio)-6-(4-hydroxy-3,5-di-tert-butylanilino)-1,3,5-triazine;
0.2 part by weight of UV absorber b, i.e. 2-(2′-hydroxy-3′,5′-di-tert-butylphenyl)-5-chlorobenzotriazole;
0.2 part by weight of UV absorber c, i.e. 2-(2′-hydroxy-3′,5′-di-tert-amylphenyl)-5-chlorobenzotriazole;
0.4 part by weight of C₁₂H₂₅OCH₂CH₂OP(═O)(OK)₂; and
0.05 part by weight of fine particles of silicon dioxide, with a particle diameter of 20 nm, and Mohs hardness number of approx. 7.

[Dope Storing Method]

In Experiment No. 1, the storing solution tank 30 in FIG. 2 was used, and had the tank body 31 with an inner volume of 5 m³ and produced from steel material of SUS316. The heat exchange medium 58 in the temperature controller 50 was supplied into the warming jackets 51-56 to set the temperature Ti of the gas/liquid interface 31c at 25° C., and the temperature TL of the liquid phase region 31d at 30° C., and the temperature Tg of the gas phase region 31e at 23° C. 0.1 m³ of the replenishing solvent 37 was contained in the liquid reservoir chamber 36 with the same composition of the solvent for preparing the dope. Furthermore, 0.2 m³ of the solvent 45 was poured into the vessel 41 of the saturated gas generator 40, the solvent 45 in mixture having the same composition as the solvent for preparing the dope. The gas 44a of nitrogen was sent through the conduit 42 having an inner diameter of 20 mm, and bubbled in the solvent 45 at a flow rate of 1 m³/min and temperature of 30° C. The saturated gas 45b was caused to flow through the conduit 47 into the tank body 31, and substituted for air in the tank body 31 for 10 minutes. The completion of the substitution was checked by gas chromatography (GC) with part of the gas in the upper space 31b.

The dope 23 prepared in the above method was poured into the storing solution tank 30 which was 2 m³ large. The valves 34 and 46 were automatic valves for opening and closing according to changes in the pressure of the upper space 31b. The valve control was responsive to drop in the pressure of the upper space 31b down from a prescribed pressure level, and caused the valve 46 to open, and caused the valve 34 to close. This filled the upper space 31b with the saturated gas 45b at the prescribed pressure. Also, the valve control was responsive to rise in the pressure of the upper space 31b up from the prescribed pressure level, and caused the valve 46 to close to interrupt the flow of the saturated gas 45b. The valve 34 was opened, to set the pressure in the upper space 31b at the prescribed pressure level. Note that the prescribed pressure level was 1.2 times of vapor pressure in the condition of the temperature Tg of the gas phase region, and specifically was 50 kPa. Then the temperature controller 38 operated to keep the replenishing solvent 37 in the liquid reservoir chamber 36 at the temperature of 23° C. The dope 23 was stored for 48 hours.

The valve 32 was opened. The pump 66 was driven to cause the dope 23 to flow through the filtration device 67 at a flow rate of 10 l/min, so as to send the dope 23 to the solution casting apparatus 120. The filtration device 67 had an initial pressure of 100 kPa, but had a pressure of 200 kPa after 3 m³ of the dope 23 had passed. According to a storing solution tank, an increase in the pressure is approximately 500 kPa. However, in the storing solution tank 30 of the invention, an increase in the pressure was as small as 100 kPa. It is concluded that the smallness in the increase in the pressure was caused by reduction in the solid content captured on the filter in the filtration device 67. This indirectly showed an effect of suppression of unwanted precipitated polymer.

[Solution Casting]

To produce the polymer film 131 according to solution casting, the solution casting apparatus 120 of FIG. 4 was used to cast the dope 23 being stored. The dope 23 was conditioned at 35° C., and cast by the die 124 on to the support belt 128 being moved by the rollers 126 and 127. The rollers 126 and 127 were conditioned at 20° C. The dope 23 was cast at a casting speed of 30 m/min and at such a flow rate that the polymer film 131 being dried would have a thickness of 80 microns. When the dope 23 became the cast film 129 having a self-supporting property on the support belt 128, the cast film 129 was stripped by the stripping roller 130 by way of the polymer film 131. Then the polymer film 131 was stretched and dried by the drier 132. Then the polymer film 131 was transferred into the drying chamber 134 conditioned in the temperature range of 120-140° C., and was transported in contact with the rollers 133. Then the polymer film 131 was sent to the cooling chamber 135, was conditioned to the temperature of 25° C. by cooling, and then was wound by the winder 136.

[Evaluation of Polymer Film]

Retardation (Rth) of the polymer film 131 in the thickness direction was measured and found 5 nm. It was found that polymer film with a reliable characteristic in the optical performance could be obtained in Experiment No. 1. Note that the retardation (Rth) is defined according to the equation of
Rth=[(nx+ny)/2−nz]×d
where nx represents a refractive index of the polymer film 131 in its web width direction;
ny represents a refractive index of the polymer film 131 in its casting direction; and
nz represents a refractive index of the polymer film 131 in its thickness direction.

The refractive indexes were measured by an ellipsometer (polarizer/analyzer) with a wavelength of 632 nm. The sign d (nm) represents an average thickness of the polymer film 131.

[Production of Dope]

Experiment No. 2 is described now. The mixed solvent was supplied from the solvent delivery tank 11 to the dissolving tank 13. Then powder or flake of cellulose triacetate (TAC) was dispersed sufficiently by stirring, and gradually poured by means of the measuring device 14. Plasticizer as additive at a suitable amount was poured, to obtain 800 kg of dope. Then the stirring blades 22 were rotated for 60 minutes at 25° C. The composition with fluidity existing presently in the dissolving tank 13 is referred to as gel-formed solution. Any of the used methyl acetate, acetone, methanol and 1-butanol had water content of 0.1 wt. % or less.

The dope was produced from the gel-formed solution by a cooling/dissolving device (not shown). A screw pump of which an axial center was warmed sent the gel-formed solution. But the gel-formed solution was cooled from a screw peripheral section, and was caused to flow past a cooling section for cooling down to −70° C. for 10 minutes. For the cooling, coolant was used, and was cooled at −90° C. by a refrigerator or freezer. The cooled dope or solution was caused to flow by a pump. During the flow, the dope was warmed to 40° C., and poured into a vessel of stainless steel. The dope was stirred at 40° C. for one (1) hour, to obtain uniformized solution, which was filtered by filter paper #63 (trade name) manufactured by Advantec MFS, Inc. and having absolute filtering precision of 10 microns.

[Material for Dope]

In the used cellulose triacetate, the total substitution degree was 2.82. The substitution degree at 6-position of acetyl group was 0.95 for hydroxyl group. The substitution of acetyl group at 6-position was 32.2% based on the total acetyl groups. The viscosity average degree of polymerization (DP) was 320. The ratio between weight average molecular weight and number average molecular weight was 0.5. The cellulose triacetate was homogeneous. The water content was 0.2 wt. %. The viscosity of 6 wt. % dichloro methane solution was 305 mPa.s. The average particle diameter and standard deviation of the particle diameter was 1.5 mm and 0.5 mm. The cellulose triacetate contained 0.1 wt. % or less of the remaining acetic acid, 0.05 wt. % of remaining Ca, 0.007 wt. % of remaining Mg, and 5 p.p.m. of remaining Fe. The extraction with acetone was 11 wt. %. The haze was 0.08. The transparency was 93.5%. The glass transition temperature Tg was 160 DEG C. The heat of crystallization was 6.2 J/g.

The materials for dope were as follows.
15 Parts by weight of particles of cellulose triacetate;
58 parts by weight of methyl acetate (as a chlorine-free compound);
5 parts by weight of methanol;
6 parts by weight of ethanol;
5 parts by weight of 1-butanol;
1 part by weight of ditrimethylol propane triacetate as plasticizer;
1 part by weight of triphenylphosphate or TPP as plasticizer;
0.2 part by weight of biphenyl diphenylphosphate as plasticizer;
0.2 part by weight of ethyl phthalyl glycol ethyl ester as plasticizer;
0.2 part by weight of UV absorber a, i.e. 2,4-bis-(n-octylthio)-6-(4-hydroxy-3,5-di-tert-butylanilino)-1,3,5-triazine;
0.2 part by weight of UV absorber b, i.e. 2-(2′-hydroxy-3′,5′-di-tert-butylphenyl)-5-chlorobenzotriazole;
0.2 part by weight of UV absorber c, i.e. 2-(2′-hydroxy-3′,5′-di-tert-amylphenyl)-5-chlorobenzotriazole;
0.05 part by weight of fine particles of silicon dioxide, with a particle diameter of 20 nm, and Mohs hardness number of approx. 7; and
0.04 part by weight of monoethyl citrate ester.

The dope 23 was stored in the same condition as Experiment No. 1. 5 m³ of the dope 23 after being stored was sent by the pump 25 to the storing solution tank 30. The replenishing solvent 37 in the liquid reservoir chamber 36 was kept at the temperature 23° C. A gas-liquid equilibrium in the tank body 31 was maintained. The dope 23 continued being stored for 48 hours.

The dope 23 after being stored was conditioned at a flow rate of 10 liters per minute by the pump 66, filtrated by the filtration device 67 and sent to the solution casting apparatus 120. The filtration device 67 had an initial pressure of 80 kPa, but had pressure of 500 kPa after 3 m³ of the dope 23 having been stored was passed through. The increase in the pressure in the use of the solution tank according to the invention was 420 kPa in contrast with approximately 800 kPa in using a solution tank according to the prior art. It was found that precipitated polymer was prevented from occurrence.

Polymer film was produced in the same condition as Experiment No. 1. Retardation (Rth) of the polymer film in the thickness direction was measured and found 10 nm. It was found that polymer film with a reliable characteristic in the optical performance could be obtained in the case of the dope containing a main solvent of methyl acetate.

Experiment No. 3 is described now. The storing solution tank 70 in FIG. 3 was used. Production of the dope was the same as that according to Experiment No. 1. The storing solution tank 70 had the tank body 71 with an inner volume of 5 m³ and produced from steel material of SUS316. The temperature Ti of the gas/liquid interface 71b was set at 25° C. The temperature TL of the liquid phase region 71c was set at 30° C. The temperature Tg of the gas phase region 71d was set at 23° C. The solvent delivery device 73 was supplied with 0.2 m³ of the solvent 79 with the same composition of the solvent for the dope in Experiment No. 1. The solvent 79 was supplied to the liquid reservoir chamber 76 in the tank body 71 by opening and closing the valve 77. Approximately 0.1 m³ of the solvent 79 was contained in the liquid reservoir chamber 76. The dope 23 was poured into the storing solution tank 70 by the pump 25. 4 m³ of the dope 23 was contained in the tank body 71. Then the degassing vent 72a was closed, to keep storing the dope 23 for 48 hours.

The dope 23 was caused by the pump 66 to flow at a flow rate of 10 l/min, and passed through the filtration device 67, before supply to the solution casting apparatus 120. The filtration device 67 had an initial pressure of 100 kPa, but had pressure of 200 kPa after 3 m³ of the dope 23 having been stored was passed through. It was found that precipitated polymer was prevented from occurrence.

Polymer film was produced by casting in the same condition as Experiment No. 1 by use of the dope. Retardation (Rth) of the polymer film in the thickness direction was measured and found 5 nm. It was found that polymer film with a reliable characteristic in the optical performance could be obtained.

Experiment No. 4 is described now. The dope 23 was stored in the storing solution tank 70 illustrated in FIG. 3. For the production of the dope 23, Experiment No. 2 was repeated. For storing of the dope 23, Experiment No. 3 was repeated except for the following items. 4 m³ of the dope 23 was stored. The liquid reservoir chamber 76 was supplied with 0.1 m³ of the replenishing solvent 80. The replenishing solvent 80 had the same composition of the solvent for the dope 23 in Experiment No. 2. After the dope 23 was stored for 48 hours, the valve 74 was opened. The dope 23 was caused by the pump 66 to flow at a flow rate of 10 l/min, and passed through the filtration device 67, before supply to the solution casting apparatus 120. The filtration device 67 had an initial pressure of 80 kPa, but had pressure of 500 kPa after 3 m³ of the dope 23 having been stored was passed through. It was found that precipitated polymer was prevented from occurrence.

Polymer film was produced by casting in the same condition as Experiment No. 2 by use of the dope after being stored. Retardation (Rth) of the polymer film in the thickness direction was measured and found 10 nm. It was found that polymer film with a reliable characteristic in the optical performance could be obtained even from the dope stored according to Experiment No. 4.

Anti-reflection film was produced from the polymer film obtained from Experiments Nos. 1 and 2, and evaluated for various items.

[Preparation of Coating Solution A for Antiglare Layer]

125 Grams of a marketed mixture DPHA (trade name, produced by Nippon Kayaku Co., Ltd.) of dipenta erythritol pentaacrylate and dipenta erythritol hexaacrylate, and
125 grams of bis(4-methacryloyl thiophenyl sulfide, MPSMA (trade name, produced by Sumitomo Seika Chemicals Co., Ltd.)
were dissolved in 439 grams of mixed solvent of methyl ethyl ketone/cyclohexanone at a ratio of 50 wt. % and 50 wt. %, to obtain a first solution. 5.0 Grams of photo polymerization initiator IRGACURE 907 (trade name, produced by Ciba Geigy Corp.), and 3.0 grams of photo sensitizer KAYACURE DETX (trade name, produced by Nippon Kayaku Co., Ltd.) were dissolved in 49 grams of methyl ethyl ketone, to obtain a second solution. The second solution was added to the first solution to obtain coating solution. The coating solution was applied and cured by ultraviolet rays, so a coating layer was formed and found to have a refraction index of 1.60. Furthermore, 10 grams of crosslinking polystyrene particles SX-200H (trade name, produced by Soken Chemical & Engineering Co., Ltd.) having an average grain diameter of 2 microns were mixed with the coating solution in the liquid phase, which mixture was agitated by a high-speed disperser for one (1) hour at a rate of 5,000 r.p.m to obtain liquid dispersion. After this, the dispersion was filtrated by the polypropylene filter having porosity with a hole diameter of 30 microns. Thus, the filtrated solution was obtained as the coating solution A for the antiglare layer.

[Preparation of Coating Solution B for Antiglare Layer]

217.0 grams of a hard coat coating solution containing dispersion of zirconium oxide (DeSolite KZ-7886A, trade name, produced by JSR Corporation) was dissolved in mixed solvent of 61.3 grams of methyl ethyl ketone and 104.1 grams of cyclohexanone, while agitated by an air disperser. The coating of the solution was applied and cured by ultraviolet rays, so a coating layer was formed and found to have a refraction index of 1.61. Furthermore, in the liquid phase of the solution, 5 grams of crosslinking polystyrene particles SX-200H (trade name, produced by Soken Chemical & Engineering Co., Ltd.) having an average grain diameter of 2 microns was added to the solution, and then was agitated by a high-speed disperser for one (1) hour at a rate of 5,000 r.p.m to obtain liquid dispersion. The liquid dispersion was filtrated by the polypropylene filter having porosity with a hole diameter of 30 microns. Thus, the filtrated solution was obtained as the coating solution B for the antiglare layer.

[Preparation of Coating Solution C for Antiglare Layer]

91 Grams of a marketed mixture DPHA (trade name, produced by Nippon Kayaku Co., Ltd.) of dipenta erythritol pentaacrylate and dipenta etythritol hexaacrylate,
199 grams of a hard coat coating solution containing dispersion of zirconium oxide (DeSolite KZ-7115, trade name, produced by JSR Corporation), and
19 grams of a hard coat coating solution containing dispersion of zirconium oxide (DeSolite KZ-7161, trade name, produced by JSR Corporation)
were dissolved in 52 grams of mixed solvent of methyl ethyl ketone/cyclohexanone at a ratio of 54 wt. % and 46 wt. %. To the solution, 10 grams of a photo polymerization initiator IRGACURE 907 (trade name, produced by Ciba Geigy Corp.) was added. The coating of the solution was applied and cured by ultraviolet rays, so a coating layer was formed and found to have a refraction index of 1.61. Furthermore, for the solution in the liquid phase, 20 grams of crosslinking polystyrene particles SX-200H (trade name, produced by Soken Chemical & Engineering Co., Ltd.) having an average grain diameter of 2 microns were mixed with 80 grams of mixed solvent of methyl ethyl ketone/cyclohexanone at a ratio of 54 wt. % and 46 wt. %, which mixture was agitated by a high-speed disperser for one (1) hour at a rate of 5,000 r.p.m to obtain liquid dispersion. To the solution, 29 grams of the liquid dispersion was added and agitated, before the solution was filtrated by the polypropylene filter having porosity with a hole diameter of 30 microns. Thus, the filtrated solution was obtained as the coating solution C for the antiglare layer.

[Preparation of Coating Solution D for Hard Coat Layer]

250 grams of a hard coat composition (72 wt. %, DeSolite KZ-7689, trade name, produced by JSR Corporation) was dissolved in mixed solvent of 62 grams of methyl ethyl ketone and 88 grams of cyclohexanone. The coating of the solution was applied and cured by ultraviolet rays, so a coating layer was formed and found to have a refraction index of 1.53. Furthermore, in the liquid phase of the solution, the solution was filtrated by the polypropylene filter having porosity with a hole diameter of 30 microns. Thus, the filtrated solution was obtained as the coating solution D for the hard coat layer.

[Preparation of Coating Solution for Low Refractive Index Layer]

8 grams of a dispersion of SiO₂ MEK-ST. (trade name, produced by Nissan Chemical Industries Ltd.), and 100 grams of methylethylketone were added to 20,093 grams of thermal crosslinking fluorine containing polymer TN-049 (trade name, produced by JSR Corporation) having a refractive index of 1.42. Note that the dispersion MEK-ST was dispersion in methyethylketone (MEK) with an average grain diameter of 10-20 nm and 30 wt. % of solid content density. Then this coating solution was agitated and filtrated by the polypropylene filter having porosity. The filter had a hole diameter of 1 micron. Thus, the filtrated coating solution was obtained as the coating solution for the low refractive index layer.

The cellulose triacetate (TAC) film with a thickness of 80 microns produced in Experiment No. 1 was coated with the hard coater coating solution D by a bar coater, and was dried at 120° C., and was cured with ultraviolet rays by a cold metal halide lamp. The cold metal halide lamp was a 160 W/cm lamp manufactured by Eye Graphics Co., Ltd, and applied ultraviolet rays at irradiance of 400 mW/cm² and intensity of 300 mJ/cm². Thus, a hard coat layer with a thickness of 2.5 microns was obtained. To a surface of this, a coating of the solution A was applied by use of a bar coater, and dried and cured with ultraviolet rays under the same condition as the hard coat layer, to form an antiglare layer A with a thickness of approximately 1.5 microns. To a surface of this, a coating of the low refractive index coating solution was applied by use of a bar coater, dried at 80° C., and thermally crosslinked at 120° C. for 10 minutes, to form a low refractive index coating layer with a thickness of 0.096 micron. The anti-reflection layer was obtained, and evaluated as follows.

(1) Mirror Reflectivity and Integral of Reflectivity

An adapter ARV-474 was set on a spectrophotometer V-550 produced by JASCO Corporation. Mirror reflectivity was measured in a wavelength range of 380-780 nm with the incidence angle of 5° and exit angle of −5°. Then an average reflectivity was calculated in the range of 450-650 nm, to evaluate the anti-reflection property. The mirror reflectivity is allowable in the practical use if in a range of 5% or less. Also for the integral of reflectivity, an adapter ILV-471 was set on the spectrophotometer V-550 produced by JASCO Corporation. Integral of reflectivity was measured in a wavelength range of 380-780 nm with the incidence angle of 5°. Then an average reflectivity was calculated in the range of 450-650 nm. The integral of reflectivity is allowable for practical use if in a range of 10% or less.

(2) Haze

Haze of the obtained anti-reflection film was measured by a haze meter MODEL 1001DP (trade name) manufactured by Nippon Denshoku Industries Co., Ltd. The haze is allowable for practical use if in a range of 15% or less.

(3) Pencil Hardness

The pencil hardness was used to represent a grade of resistance to scratches, and according to JIS-K-5400. The anti-reflection film was set in a controlled environment with the temperature of 25° C. and the humidity of 60% RH for two (2) hours. After this, the film surface of the anti-reflection film 11b was scratched with a 3H test pencil determined by JIS-S-6006. Thereby, a force of 1 kg was applied to the test pencil and for five times. For the evaluation of the pencil hardness, three grades of A, B and F were used. Five hardness values were compared, so that one of the hardness values that is that highest among the five values was determined as an evaluated pencil hardness.

A: Good, as no scratch remained on the film surface after the five tests.

B: Passing, as only one or two scratches remained on the film surface after the five tests.

F: Poor, as three or more scratches remained on the film surface after the five tests.

(4) Measurement of a Contact Angle

The anti-reflection film was set in a controlled environment with the temperature of 25° C. and the humidity of 60% RH for two (2) hours. After this, the contact angle of the anti-reflection film with respect to water was measured to obtain a value of an anti-fingerprint property. The contact angle is allowable for practical use if in a range of 90-180° C.

(5) Chromaticity

Values of L*, a* and b* were calculated according to the measured spectrum of reflection, the L*, a* and b* being values for chromaticity (color balance) in the L*a*b* space according to CIE 1976 which represents chromaticity of direct reflected light derived from 5° incident light of the CIE standard light source D65. The chromaticity is allowable for practical use with L* in a range from 0 to +15, a* in a range from 0 to +20, and b* in a range from −30 to 0.

(6) Coefficient of Dynamic Friction

Surface smoothness was evaluated by utilizing a coefficient of dynamic friction. The anti-reflection film was set in a controlled environment with the temperature of 25° C. and the humidity of 60% RH for two (2) hours. After this, the friction coefficient of dynamic friction of the anti-reflection film was measured by a dynamic friction coefficient measuring device HEIDON-14 (trade name, manufactured by Shinto Scientific Co., Ltd.) having a stainless steel ball with diameter of 5 mm, and at load of 100 grams and speed of 60 cm/min. The friction coefficient of dynamic friction is allowable for practical use if in a range of 0.15 or less.

(7) Evaluation of the Antiglare Properties

An image of a fluorescent lamp of 8,000 cd/m² without a lampshade, reflector or louver was mirrored on each surface of the anti-reflection film of the samples. An unsharp degree of a reflected image of the flourescent lamp on the anti-reflection film was evaluated by human eyes.

AA: considerably unsharp state of fluorescent light, with sufficient antiglare properties.

A: comparably unsharp state of fluorescent light, with a faintly discernible contour of a lamp image.

B: comparably sharp state of fluorescent light, with a clearly discernible contour of a lamp image.

F: very sharp state or no unsharp state of fluorescent light, extremely short of antiglare properties.

Then another sample of anti-reflection film was produced from the polymer film of Experiment No. 1 and by use of the antiglare layer coating solution B in place of the antiglare layer coating solution A. The condition was repeated except for the coating solution B. A sample of third anti-reflection film was produced by use of the antiglare layer coating solution C in place of the antiglare layer coating solution A. The condition was repeated except for the coating solution C. Further three samples of anti-reflection film of Experiment No. 2 was produced by use of respectively the antiglare layer coating solutions A, B and C. The condition was repeated except for the selection of the coating solutions. All of those samples were evaluated. Results of the evaluation were found by the observation, as listed in the table below.

| Polymer film | | | | | | |
|---|---|---|---|---|---|---|
| Antiglare | Experiment No. 1 | | | Experiment No. 2 | | |
| layer | A | B | C | A | B | C |
| Average | 1.1 | 1.1 | 1.1 | 1.2 | 1.1 | 1.0 |
| reflectivity | | | | | | |
| (%) of mirror | | | | | | |
| reflectivity | | | | | | |
| Average | 2.0 | 2.0 | 2.0 | 2.2 | 2.0 | 1.9 |
| reflectivity | | | | | | |
| (%) of | | | | | | |
| integral of | | | | | | |
| reflectivity | | | | | | |
| Haze (%) | 8 | 8 | 12 | 8 | 8 | 10 |
| Pencil | A | A | A | A | A | A |
| hardness (3H) | | | | | | |
| Contact angle | 103° | 103° | 103° | 103° | 102° | 105° |
| Chromaticity | 10/ | 9/ | 9/ | 10/ | 9/ | 10/ |
| L*/a*/b* | 1.9/ | 2.0/ | 1.7/ | 2.0/ | 2.0/ | 1.8/ |
| | 1.3 | −4.0 | 0.2 | 1.3 | 1.3 | 1.2 |
| Dynamic | 0.08 | 0.08 | 0.08 | 0.09 | 0.08 | 0.06 |
| friction | | | | | | |
| coefficient | | | | | | |
| Antiglare | AA | AA | AA | AA | AA | AA |
| property | | | | | | |

It is concluded from the above table that the anti-reflection film as optical polymer film produced from dope stored coating to the invention had good antiglare and anti-reflecting ability, weak chromaticity and also good results in various items. The surface quality was good owing to the reliably suitable values of the pencil hardness, the anti-fingerprint property, and a friction of dynamic friction.

[Production of Polarizing Plate and Evaluation]

An element of polarizer was prepared by a process in which the polyvinyl alcohol was stretched and iodine was adsorbed to the polyvinyl alcohol. Then the anti-reflection film obtained from Experiments Nos. 1-8 were attached to respectively opposite surfaces of the polarizer, so that a test polarizing plate is obtained. The polarizing plates were set in a controlled environment with atmosphere the temperature of 60° C. and the humidity of 90% RH for 500 hours.

Then a polarizing coefficient PY was determined from parallel transmittance Yp and crossed transmittance Yc in the visible light region and according to the following condition.
PY=[(Yp−Yc)/(Yp+Yc)]^{1/2}×100(%)

As a result, the polarizing coefficient PY was 99.6% or more, and had sufficiently high durability, in any of the polarizing plates by use of the films according to Experiments Nos. 1-4. It was observed that the polymer film produced from the dope stored according to the storing of the invention could be advantageously used in a polarizing plate.

Then antiglare anti-reflection polarizers were produced by use of polymer films derived from Experiments Nos. 1-4. Liquid crystal display panels were produced by attachment of each one of the antiglare anti-reflection polarizers to set the anti-reflection layer on a front surface. As a result, good contrast was obtained owing to lack of unwanted reflection of external light. The antiglare property was effective in keeping inconspicuous a reflected image, to obtain a well recognizable state. Also, the anti-fingerprint property was acceptably high. In conclusion, it was found that the polymer film obtained according to the storing, condensing, and solution casting steps of the invention could have high performance as optical element, and preferably could be used as an element for the liquid crystal display panel.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A solution tank for storing solution containing solute and solvent, comprising:
a tank body; and
a flow path for flow of saturated gas generated by a saturated gas generator into said tank body, wherein said saturated gas contains a main component of said solvent.

2. A solution tank as defined in claim 1, wherein said saturated gas maintains gas-liquid equilibrium.

3. A solution tank as defined in claim 1, further comprising at least one warming device for adjusting temperature of said tank body.

4. A solution tank as defined in claim 3, wherein said at least one warming device comprises plural warming devices arranged in a direction of a depth of said tank body.

5. A solution tank as defined in claim 4, further comprising a temperature controller for discretely controlling temperature of said plural warming devices.

6. A solution tank as defined in claim 5, wherein a condition of
Tg≦Ti≦TL
is satisfied, where TL (° C.) is temperature of a liquid phase region inside said tank body;
Ti (° C.) is temperature of a gas/liquid interface inside said tank body; and
Tg (° C.) is temperature of a gas phase region inside said tank body.

7. A solution tank as defined in claim 3, further comprising an auxiliary saturated gas generator, disposed in said tank body, for generating said saturated gas that contains said main component of said solvent, and for causing contact of said saturated gas with said solution.

8. A solution tank as defined in claim 7, wherein said auxiliary saturated gas generator includes a liquid reservoir chamber, disposed in one portion of said tank body, for storing said main component of said solvent in said liquid phase.

9. A solution tank as defined in claim 8, wherein a condition of
Ti−10≦Ts(° C.)≦Ti+10
is satisfied, where Ti (° C.) is temperature of a gas/liquid interface inside said tank body; and
Ts (° C.) is temperature of said liquid reservoir chamber.

10. A solution tank as defined in claim 3, wherein said solute includes at least one polymer.

11. A solution tank as defined in claim 10, wherein said polymer comprises cellulose acylate.

12. A solution tank as defined in claim 3, wherein said main component of said solvent is chlorine-free solvent.

13. A solution tank as defined in claim 12, wherein said chlorine-free solvent comprises acylic acid ester.

14. A solution tank as defined in claim 3, wherein said solution tank is positioned downstream from a dissolving tank, and supplied with said solution thereby, and said dissolving tank produces said solution by dissolving said solute in said solvent.

15. A solution tank as defined in claim 3, wherein said solution tank is positioned upstream from a solution casting apparatus, and supplies said solution thereto, and said solution casting apparatus produces polymer film from said solute by casting said solution.

16. A solution tank for storing solution containing solute and solvent, comprising:
a tank body; and
an auxiliary saturated gas generator, disposed in said tank body, for generating saturated gas that contains a main component of said solvent, and for causing contact of said saturated gas with said solution, to maintain gas-liquid equilibrium.

17. A solution tank as defined in claim 16, wherein said auxiliary saturated gas generator includes a liquid reservoir chamber, disposed in one portion of said tank body, for storing said main component of said solvent in said liquid phase.

18. A solution tank as defined in claim 17, wherein a condition of
Ti−10≦Ts(° C.)≦Ti+10
is satisfied, where Ti (° C.) is temperature of a gas/liquid interface inside said tank body; and
Ts (° C.) is temperature of said liquid reservoir chamber.

19. A solution storing method of storing solution containing solute and solvent in a solution tank, comprising a step of:
supplying saturated gas containing a main component of said solvent into said solution tank in supplying said solution, for maintaining gas-liquid equilibrium.

20. A solution storing method as defined in claim 19, wherein said gas-liquid equilibrium is maintained so that precipitation of said solute is prevented.

21. A solution storing method as defined in claim 19, wherein plural warming devices are used, and arranged in a direction of a depth of said solution tank, for adjusting temperature of said solution tank.

22. A solution storing method as defined in claim 21, wherein a condition of
Tg≦Ti≦TL
is satisfied, where TL (° C.) is temperature of a liquid phase region inside said solution tank;
Ti (° C.) is temperature of a gas/liquid interface inside said solution tank; and
Tg (° C.) is temperature of a gas phase region inside said solution tank.

23. A solution storing method as defined in claim 21, wherein an auxiliary saturated gas generator is used in said solution tank, for generating said saturated gas that contains said main component of said solvent, and for maintaining gas-liquid equilibrium.

24. A solution storing method as defined in claim 21, wherein said solute includes at least one polymer.

25. A solution storing method as defined in claim 21, wherein said main component of said solvent is chlorine-free solvent.

26. A solution storing method as defined in claim 21, wherein said solution is produced by dissolving said solute in said solvent, and then supplied into said solution tank.

27. A solution storing method as defined in claim 21, wherein said solution tank supplies said solution for a solution casting process, and said solution casting process produces polymer film from said solute by casting said solution.

28. A solution storing method of storing solution containing solute and solvent in a solution tank, comprising a step of:
generating saturated gas that contains a main component of said solvent by using an auxiliary saturated gas generator in said solution tank, said saturated gas maintaining gas-liquid equilibrium.
